(19) United States
(12) Patent Application Publication
(10) Pub. No.: US 2009/0304884 A1
(43) Pub. Date: Dec. 10, 2009

(54) Produce treating apparatus

(76) Inventor: Lionel Gordon Evans, Auckland (NZ)

Correspondence Address: JACOBSON HOLMAN PLLC, 400 SEVENTH STREET N.W., SUITE 600, WASHINGTON, DC, 20004, US

(21) Appl. No.: 11/921,863

(22) PCT Filed: Jun. 2, 2006
(86) PCT No.: PCT/NZ2006/000137

§ 371 Date: Apr. 16, 2009

(30) Foreign Application Priority Data
Jun. 9, 2005 (NZ) 540672
Oct. 13, 2005 (NZ) 543023

(51) Int. Cl. A23B 7/14; A23N 12/02; A23L 3/28; A23B 7/157

(52) U.S. Cl. 426/321; 15/3.14; 15/3.13; 99/516; 99/534

(57) ABSTRACT

Apparatus for treating comestible pieces to prolong freshness having, in series,
(I) UV irradiation apparatus to irradiate the produce pieces whilst in a first liquid system as carrier,
(II) a first immersion apparatus defined at least in part by a first drag through tube conveyor to receive produce pieces directly or indirectly from step (I) apparatus, to immerse them in a different liquid system, and to discharge produce pieces, and
(III) a second immersion apparatus defined at least in part by a second drag through tube conveyor to receive the discharge from the first immersion apparatus and to discharge the produce pieces.

### TECHNICAL FIELD

The present invention relates to apparatus, methods, uses and products capable of providing a liquid dipping process for items such as pieces [e.g. chunks, slices, etc] of a live or fresh vegetable or fruit (i.e. “produce”).

### BACKGROUND ART

A process that might be utilised is an apple or other treatment regime substantially as disclosed in the PCT Patent Specification WO03/017773 of HortResearch or which may be a treatment regime such as disclosed by various Mantrose Haueser Company patent (e.g. U.S. Pat. Nos. 5,925,395 and 5,939,117). Thus the items can be mechanically produced pieces of a fresh and/or live fruit and/or vegetable (e.g. apples, pears, squash, pumpkin, carrot, radish, persimmons, broccoli, cauliflower, kumara, onions, beans, etc).

Such procedures require immersion of the produce in a liquid or series of liquids. Such immersions desirably require low volume baths of liquid(s) at desired (e.g. tuned) content and/or temperature. Such baths should also be cheap to construct as part of an overall treatment plant. Such apparatus should also keep space requirements low.

Rotary paddled systems have sometimes been utilised as a low space requiring immersion bath, the wall of the bath assumes a form similar to that of the locus of the distal part of the paddles of the rotary wheel.

The present invention recognises a significant advantage can arise from the use of a flighted endless conveyor in that it has the prospect of providing a controlled dwell time in liquid without reliance on a greater volume of liquid over that which might be used in a paddled wheel immersion system. The present invention also provides cost advantages over alternatives, such as disclosed in our WO04/095954 material immersion apparatus.

It is therefore an object of the present invention to provide apparatus, methods, uses, etc which will at least go some way to take one or more advantage from the use of a flighted endless conveyor for the purpose of immersion of items in a liquid.

As used herein the term “liquid” includes any fluid which has a liquid component, i.e. it can include mixtures of liquids, solutions, suspensions, emulsions, suspo-emulsions, etc.

### DISCLOSURE OF INVENTION

In another aspect the invention consists in apparatus for immersing items, said apparatus comprising or including

a tube having an inlet and an outlet end and having between said inlet and outlet ends a region in which liquid can pool,

a liquid inlet and outlet into and from the tube to provide a pool of liquid in said region of the tube where liquid can pool,

an endless flighted conveyor passing through the tube,

a sprocket externally of the tube to move the conveyor flights into, in and from the tube,

a pick up zone at or adjacent the inlet end of the tube from which items to be immersed can be dragged by a flight of the conveyor, and

a discharge zone at or adjacent the outlet end of the tube from which items that have been dragged through the pooled liquid in the tube are discharged.

In another aspect the invention consists in apparatus for serially immersing items, said apparatus comprising or including

a first tube having an inlet and an outlet end and having between said inlet and outlet ends a region in which a first liquid can pool,

a liquid inlet and outlet into and from the first tube to provide a pool of a first liquid in said region of the first tube where a first liquid can pool,

an endless flighted conveyor (“first conveyor”) passing through the first tube,

a sprocket (“first sprocket”) externally of the first tube to move the conveyor in flights into, in and from the first tube,

a pick up zone at or adjacent the inlet end of the first tube from which items to be immersed in the first liquid can be dragged by a flight of the conveyor,

a discharge and transfer zone at or adjacent the outlet end of the first tube from which items that have been dragged through the pooled first liquid in the first tube are discharged,

a second tube having an inlet and an outlet end and having between said inlet and outlet ends a region in which a second liquid can pool,

a liquid inlet and outlet into and from the second tube to provide a pool of a second liquid in said region of the second tube where a second liquid can pool,

an endless flighted conveyor (“second conveyor”) passing through the second tube,

a sprocket (“second sprocket”) externally of the second tube to move the conveyor flights into, in and from the second tube,

a pick up zone at or adjacent the inlet end of the second tube to which items from said discharge and transfer zone are transferred and from which the items to be immersed in the second liquid can be dragged by a flight of the conveyor, and

a discharge zone at or adjacent the outlet end of the second tube from which items that have been dragged through the pooled second liquid in the second tube are discharged.

In another aspect the invention consists in apparatus for serially immersing UV light treated fresh and/or live vegetable and/or fruit pieces (“items”), said apparatus comprising or including

a first tube having an inlet and an outlet end and having between said inlet and outlet ends a region in which at least water can pool,

a liquid inlet and outlet into and from the first tube to provide a pool of at least water in said region of the first tube where at least water can pool,

an endless flighted conveyor passing through the first tube,

a sprocket (“first sprocket”) externally of the first tube to move the conveyor in flights into, in and from the first tube,

a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,

a discharge and transfer zone at or adjacent the outlet end of the first tube from which items that have been dragged through the pooled first liquid in the first tube are discharged,

a second tube having an inlet and an outlet end and having between said inlet and outlet ends a region in which a second liquid can pool,

a liquid inlet and outlet into and from the second tube to provide a pool of a liquid being at least water at or near 0° C. [and with (optionally) a calcium cation and/or ascorbate anion inclusion] in said region of the second tube where a second liquid can pool,

an endless flighted conveyor passing through the second tube,

a sprocket (“second sprocket”) externally of the second tube to move the conveyor flights into, in and from the second tube,

a pick up zone at or adjacent the inlet end of the second tube to which items from said discharge and transfer zone are transferred and from which the items to be immersed in the liquid can be dragged by a flight of the conveyor, and

a discharge zone at or adjacent the outlet end of the second tube from which items that have been dragged through the pooled liquid in the second tube are discharged.

In another aspect the invention consists in apparatus for a method of enhancing food safety and longevity of produce that has been subject to a mechanical reduction, said apparatus having,
in series,
(I) UV irradiation apparatus to irradiate the produce pieces whilst in a first liquid system as carrier,
(II) a first immersion apparatus to receive produce pieces directly or indirectly from step (I) apparatus, to immerse them in a different liquid system, and to discharge produce pieces, and
(III) a second immersion apparatus to receive the discharge from the first immersion apparatus and to discharge the produce pieces,

wherein the step (II) apparatus has

a first tube having an inlet and an outlet end and having between said inlet and outlet ends a region in which at least water can pool,

a liquid inlet and outlet into and from the first tube to provide a pool of at least water in said region of the first tube where at least water can pool,

an endless flighted conveyor passing through the first tube,

a sprocket (“first sprocket”) externally of the first tube to move the conveyor in flights into, in and from the first tube,

a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,

a discharge and transfer zone at or adjacent the outlet end of the first tube from which items that have been dragged through the pooled first liquid in the first tube are discharged,

and wherein the step (III) apparatus has

a second tube having an inlet and an outlet end and having between said inlet and outlet ends a region in which a second liquid can pool,

a liquid inlet and outlet into and from the second tube to provide a pool of a liquid being at least water at or near 0° C. [and with (optionally) a calcium cation and/or ascorbate anion inclusion] in said region of the second tube where a second liquid can pool,

an endless flighted conveyor passing through the second tube,

a sprocket (“second sprocket”) externally of the second tube to move the conveyor flights into, in and from the second tube,

a pick up zone at or adjacent the inlet end of the second tube to which items from said discharge and transfer zone are transferred and from which the items to be immersed in the liquid can be dragged by a flight of the conveyor, and

a discharge zone at or adjacent the outlet end of the second tube from which items that have been dragged through the pooled liquid in the second tube are discharged.

Preferably the step (I) apparatus irradiation apparatus is adapted to receive produce pieces into an induced and/or forced liquid vortex, there being at least one UV source capable of irradiating such produce pieces whilst in the vortex and/or downstream thereof.

Preferably at least some if not all of the flights of said conveyor(s) are perforate or contoured to reduce sticking of items and/or pieces thereto.

Preferably at least one discharge zone involve a deflector adapted to deflect and cause vibration of the flight to assist discharge of items or pieces (e.g. by flick off).

Preferably said tube or tubes are at least substantially circular in section.

Preferably said tubes are of a stainless steel.

Preferably said tubes have at least substantially horizontal regions at the inlet and at the outlet ends thereof. Preferably the region of the tube(s) to carry a pulled liquid is below the level of both the inlet and the outlet of that tube thereby avoiding the need for a locus of the tube that would prevent run out.

Preferably said endless flighted conveyor involves a cable or the equivalent (preferably sleeved) to which is affixed the flights.

Preferably said flights are sufficiently loosely fitted to the tube so as to allow flow past of liquid.

Preferably the flights are of a material such as nylon. Preferably the cable is of stainless steel. Preferably the cable is sleeved with nylon or other material to which nylon can be fixed.

Preferably the UV irradiation apparatus is of a kind substantially as disclosed in WO 03/092392.

Preferably the apparatus is adapted for a procedure of any of the kinds indicated by the previously mentioned patent specifications and/or as hereinafter described.

Preferably the sprockets are individually drivable i.e. so it is not necessary for each of the preferably serially related endless flighted conveyors to move at the same speed.

Preferably a vibratory screen, vibratory conveyor and/or air knife is provided for reducing liquid carry over [e.g. from (I) to (II) or (II) to (III)].

In another aspect the invention consists in apparatus for a method of enhancing food safety and longevity of produce that has been subject to a mechanical reduction, said apparatus having,
in series,
(I) UV irradiation apparatus to irradiate the produce pieces whilst in a first liquid system as carrier, [and optionally a liquid recovery and/or recycle system that involves a vibratory conveyor adapted to shed excess liquid from the produce pieces]
(II) a first immersion apparatus to receive produce pieces directly or indirectly from step (I) apparatus, to immerse them in a different liquid system, and to discharge produce pieces, and
(III) a second immersion apparatus to receive the discharge from the first immersion apparatus and to discharge the produce pieces,

wherein the step (II) apparatus has

a first tube having an inlet and an outlet end and having between said inlet and outlet ends a region in which at least water can pool,

a liquid inlet and outlet into and from the first tube to provide a pool of at least water in said region of the first tube where at least water can pool,

an endless flighted conveyor passing through the first tube,

a sprocket (“first sprocket”) externally of the first tube to move the conveyor in flights into, in and from the first tube,

a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,

a discharge and transfer zone at or adjacent the outlet end of the first tube from which items that have been dragged through the pooled first liquid in the first tube are discharged,

and wherein the step (III) apparatus has

a second tube having an inlet and an outlet end and having between said inlet and outlet ends a region in which a second liquid can pool,

a liquid inlet and outlet into and from the second tube to provide a pool of a liquid being at least water at or near 0° C. [and with (optionally) a calcium cation and/or ascorbate anion inclusion] in said region of the second tube where a second liquid can pool,

an endless flighted conveyor passing through the second tube,

a sprocket (“second sprocket”) externally of the second tube to move the conveyor flights into, in and from the second tube,

a pick up zone at or adjacent the inlet end of the second tube to which items from said discharge and transfer zone are transferred and from which the items to be immersed in the liquid can be dragged by a flight of the conveyor, and

a discharge zone at or adjacent the outlet end of the second tube from which items that have been dragged through the pooled liquid in the second tube are discharged.

The invention also is a method of serially immersing UV light treated fresh and/or live vegetable and/or fruit pieces (“items”) which involves the steps of using apparatus of the present invention to drag the items through a first liquid system and then to drag the items through a second liquid system.

### BRIEF DESCRIPTION OF DRAWINGS

Preferred forms of the present invention will now be described with the accompanying drawings in which

FIG. 1 is a flow diagram depicting a preferred form of the present invention where for the first and second immersion apparatus each has an endless flighted conveyor adapted to drag the produce using its flights through tubes configured so as to have a liquid pooling region about part of the locus thereof,

FIG. 2 show features of interest about the flighted conveyor at a discharge zone (chute, vibrating screen, vibratory conveyor, and/or air; knife not being shown), and

FIG. 3 shows in a flow diagram a preferred plant design/operating process suitable for at least apples.

The present invention will now be described with reference to the accompanying drawings and processes as disclosed in WO03/017773 or variants thereof. In its simplest form as will be described a radiation apparatus applies UV light to the produce pieces in a first liquid system whereupon there is then forced immersion in a second liquid system after some shedding of excess liquid (preferably with a vibrating conveyor, vibrating screen and/or air knife to avoid potential contamination) of the first liquid system from the produce pieces. The forced immersion can be in one or more liquid systems. Preferably there is a second immersion preferably after shedding of excess liquid from the first immersion. Temperatures can vary throughout the process as suggested in the aforementioned WO03/017773.

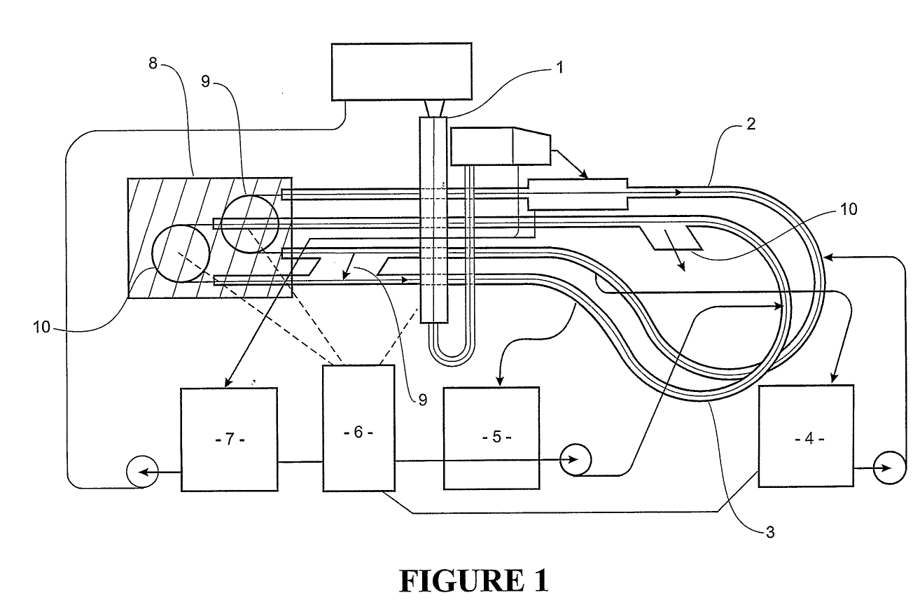

In the apparatus of FIG. 1, the UV irradiation apparatus (e.g. as suitable for WO 03/017773 process and as disclosed in WO 03/092392) is shown with a receiving hopper above the tube assembly 1 which is to irradiate the produce (e.g. as pieces) with UV sources external of a vertical fall tube of UV transparent material in which the vortex is created. The pieces descend in the induced or forced vortex down to an outlet tube for liquid recovery and then transfer of produce into the intake zone of the first immersion apparatus 2. The first immersion apparatus is in the form of a tube having a cable or otherwise supported flight system adapted to pass through the tube to carry down into the liquid pooling region (preferably a circularly pathway) of the locus of the tube the produce for immersion prior to discharge of the produce at 9 into the second immersion apparatus 3 which is of a like kind but which has a discharge at 10.

Preferably each of the two apparatus 2 and 3 is similar in so far as operation is concerned reliant on sprockets 9 and 10 respectively, each externally of its tube such that each can be independently driven as far as speed and thus dwell time is concerned. Such conveyor systems can use seamless stainless steel tubes (e.g. any size including, for example, 300 mm ID) with a stainless steel cable carrying disc-like flights (e.g. of TEFLON), preferably perforate, fixed to a plastics (e.g. TEFLON™) sheathing of the cable. The SS tubes should be bent smoothly (e.g. by the Cojafex Induction Bending process, see for example U.S. Pat. No. 4,596,123).

It has been found that stainless steel tubes of, for example, 100 to 500 mm ID (preferably 300 mm internal diameter) tubing of requisite thickness, when bent smoothly to the pooling forms depicted in FIG. 1, such that there is a substantially horizontal lead to and a substantially horizontal lead from part of a circular locus [two thirds of which is below the axis of rotation of the circular locus form] provides a structure that is easily fitted one relative to the other [with the stagger as shown or not] more or less as free standing proximate structures requiring little more that a couple of standards, (i.e. steel posts or the like) for support. Such structural SS members as are preferred also lend themselves to the SS or plastics tubing inlets and outlets as required to provide for level control of the pooling liquids in each lower circular region of the pooling locus, i.e. in the case of one circuit a heating liquid and in the case of the other a chilling and preserving liquid.

Shown in the diagram is a heating unit 4 (electrical immersion or other) for the liquid of the first immersion apparatus 2 and a chilling unit 5 (e.g. a sludge ice BELUGA™ type chilling unit) for the liquid of the second immersion apparatus 3.

A control unit 5 to centrally control the electrical functions of the apparatus is provided. The apparatus controls the sprockets (shown as connected to 5 by the broken lines) individually as to speed of rotation as well as the heating unit 4, the chilling unit 5 and the circulation system 7 adapted to receive liquid of the UV apparatus 1 (i.e. the first liquid).

In the form of the invention as shown in FIG. 1, the first liquid is that of the apparatus 1 and recycled by 7, the second liquid is that from apparatus 4 and in apparatus 2 and the third liquid is that chilled by 5 and of apparatus 3. To the extent that there can be any recycling, there is recycling consistent with the needs of a treatment regime of a kind as previously contemplated.

In a particularly preferred procedure in accordance with the present invention such as might have applicability with apples, UV irradiation occurs in a low strength calcium chloride composition (preferably impregnated with Ca Cl₂). Strengths of that composition can range significantly but should generally be less than 5% w/w and preferably less than 1% w/v, e.g. preferably about 0.2% w/v.

The hot treatment that follows preferably is in water and preferably just plain water. Preferably the heating is for the purpose as stated in the aforementioned patent specifications, the full contents of which are here included by way of reference. The treatment for that purpose of controlling respiration is not such as to blanch or cook and preferably is in the range from ambient or 15° C. (whichever is the lower) to 70° C. (preferably less than 60° C.). Preferably the temperature is from 15 to 55° C.

The final liquid system is of chilled water with a preservative inclusion and whilst a variety of different preservative options exists a preferred option is calcium ascorbate or products that provide such a system. The preservative should be level when expressed as calcium ascorbate at up to 10% w/v calcium ascorbate but preferably less than 5% w/v. A particularly preferred concentration is about 3% w/v when expressed as calcium ascorbate.

A preferred temperature for the composition is that which is assumed from a close proximity slush ice heat exchange system for the cooling liquid, i.e. approaching 0° C.

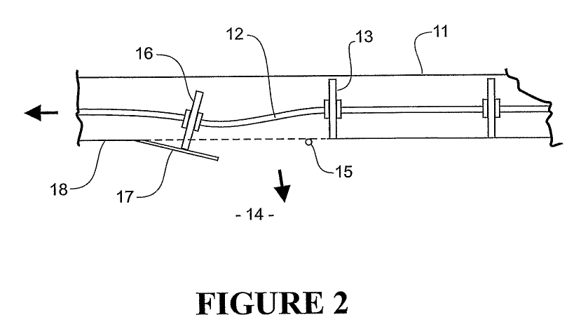

FIG. 2 shows the interesting prospect of the drag conveyor at a discharge zone. Such a discharge zone (shown by the large arrow but not showing any chute) has a cutting away or a discontinuation of the tube 11 of apparatus of the form of 3 or 2. The TEFLON sheathed stainless steel cable 12 has fitted on TEFLON disc like flights 13 but to a diameter of sufficient clearance as far as its diameter or radius is concerned with respect to the tube internal diameter to allow water for treating solution flow past whilst still conveying up from the immersion part of the tube 11 the pieces to be deposited as the zone 14. For example a tonne/hr operable apparatus with 300 mm ID tubing would preferably have discs of each flight to a diameter about 10 mm less.

To assist each of the flights 13 is preferably perforated by a plurality of transverse openings to reduce suction on pieces of fruit, vegetable or the like produce that might otherwise wish to stick to a flight. In addition a projection or disturbance 15 can be provided which will cause a flicking of the disc like flight 13 as it passes to the left.

There is a tendency, when unsupported by the tube 11, for the flighted conveyor to fall and in this respect it can be seen that a conveyor disc 16 can be assisted upwardly by a ramping portion 17 leading to the tube 18 [in its entirety, if desired, or otherwise simply along an appropriate guide] to the sprocket 9 or 10 as the case may be.

The types of sprocket 9 and 10 are those that will accommodate with appropriate openings, set ins, rebates or the like each of the flights so that the drive is on the cable primarily but there is provision for the placement of the flights without distortion thereof.

The invention envisages a ballast control for the V irradiation apparatus so that a 240V bulb/tube set, if desired, can run on, say, 60V at the lamps.

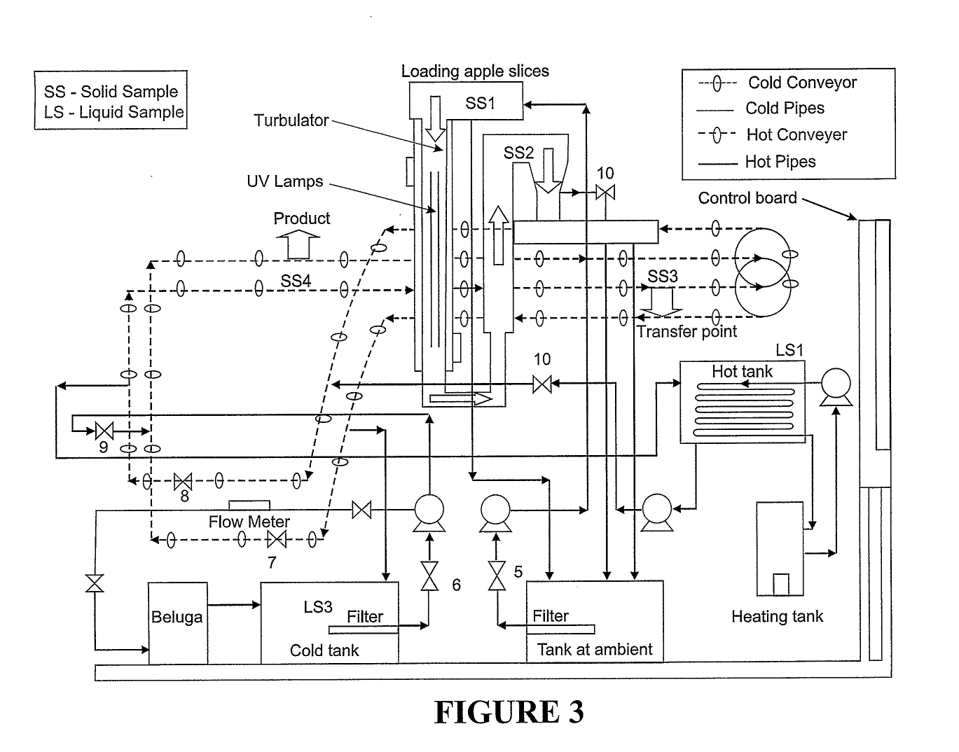

FIG. 3 shows in a flow diagram a plant design/operating process suitable for the specification of Table 1. “VIB” refers to vertical immersion baths.

TABLE 1

| 1.1 | General | | |
|---|---|---|---|
| | Product | Fresh Sliced Apples - | |
| | | (10 mm × 25 mm × 65) | |
| | Maximum Product Throughout | 1000 | kg per hour |
| | Nominal Processing hours per day | 8 | hours |
| | Nominal Throughput per day | 8,000 | kg |
| | Peak Heat Load Factor | 1.0 | |
| | Max Ambient Water Temperature | 20.0° | C. |
| | Initial Apple Temperature | 12° | C. |
| 1.2 | Turbulator Section | | |
| | Water Flow Rate | 10 | Litres per second |
| | Process Water Temperature | Ambient | |
| 1.3 | Heating Section | | |
| | Process Fluid Temperature | 55° | C. |
| | Product Inlet Temperature - | 12.0° | C. |
| | Average | | |
| | Product Outlet Temperature - | 52° | C. |
| | Surface | | |
| | Product Outlet Temperature - | 36° | C. |
| | Mass Average | | |
| | Maximum Immersion Time | 1.5 | minutes |
| | VIB Material | 316 SS 6″ Tube | |
| | Density of product in HOT VIB | 15% | |
| | Number of HOT VIB Tubes | 1 | |
| | Maximum Quantity of apples | 25 | kg |
| | per VIB Tube | | |
| | Wetted Length per VIB | Approx 9 metres | |
| | Ingredients added to water | NO | |
| 1.4 | Cooling Section | | |
| | Process Fluid Temperature | 0.0° | C. |
| | Product Inlet Temperature - | 36.0° | C. |
| | Mass Average | | |
| | Product Inlet Temperature - | 52.0° | C. |
| | Surface | | |
| | Product Outlet Temperature - | 3.0 to 8° | C. |
| | Mass Average | | |
| | Product Outlet Temperature - | 3.0° | C. |
| | Surface | | |
| | Maximum Immersion Time | 3 | minutes |
| | VIB Material | 316 SS 6″ Tube | |
| | Density of product in Cold VIB | 15% | |
| | Number of Cold VIB Tubes | 2 | |
| | Maximum Quantity of apples | 25 | kg |
| | per VIB Tube | | |

| | |
|---|---|
| Wetted Length per VIB | Approx 9 metres |
| Ingredients added to water | YES |

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

1-17. (canceled)

18. An apparatus for immersing items, said apparatus comprising or including
a tube having an inlet and an outlet end and having between said inlet and outlet ends a region in which liquid can pool,
a liquid inlet and outlet into and from the tube to provide a pool of liquid in said region of the tube where liquid can pool,
an endless flighted conveyor passing through the tube,
a sprocket externally of the tube to move the conveyor flights into, in and from the tube,
a pick up zone at or adjacent the inlet end of the tube from which items to be immersed can be dragged by a flight of the conveyor, and
a discharge zone at or adjacent the outlet end of the tube from which items that have been dragged through the pooled liquid in the tube are discharged.

19. An apparatus for serially immersing items, said apparatus comprising or including
a first tube having an inlet and an outlet end and having between said inlet and outlet ends a region in which a first liquid can pool,
a liquid inlet and outlet into and from the first tube to provide a pool of a first liquid in said region of the first tube where a first liquid can pool,
an endless flighted conveyor (“first conveyor”) passing through the first tube,
a sprocket (“first sprocket”) externally of the first tube to move the conveyor in flights into, in and from the first tube,
a pick up zone at or adjacent the inlet end of the first tube from which items to be immersed in the first liquid can be dragged by a flight of the conveyor,
a discharge and transfer zone at or adjacent the outlet end of the first tube from which items that have been dragged through the pooled first liquid in the first tube are discharged,
a second tube having an inlet and an outlet end and having between said inlet and outlet ends a region in which a second liquid can pool,
a liquid inlet and outlet into and from the second tube to provide a pool of a second liquid in said region of the second tube where a second liquid can pool,
an endless flighted conveyor (“second conveyor”) passing through the second tube,
a sprocket (“second sprocket”) externally of the second tube to move the conveyor flights into, in and from the second tube,
a pick up zone at or adjacent the inlet end of the second tube to which items from said discharge and transfer zone are transferred and from which the items to be immersed in the second liquid can be dragged by a flight of the conveyor, and
a discharge zone at or adjacent the outlet end of the second tube from which items that have been dragged through the pooled second liquid in the second tube are discharged.

20. An apparatus for serially immersing UV light treated fresh and/or live vegetable and/or fruit pieces (“items”), said apparatus comprising or including
a first tube having an inlet and an outlet end and having between said inlet and outlet ends a region in which at least water can pool,
a liquid inlet and outlet into and from the first tube to provide a pool of at least water in said region of the first tube where at least water can pool,
an endless flighted conveyor passing through the first tube,
a sprocket (“first sprocket”) externally of the first tube to move the conveyor in flights into, in and from the first tube,
a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,
a discharge and transfer zone at or adjacent the outlet end of the first tube from which items that have been dragged through the pooled first liquid in the first tube are discharged,
a second tube having an inlet and an outlet end and having between said inlet and outlet ends a region in which a second liquid can pool,
a liquid inlet and outlet into and from the second tube to provide a pool of a liquid being at least water at or near 0° C. [and with (optionally) a calcium cation and/or ascorbate anion inclusion] in said region of the second tube where a second liquid can pool,
an endless flighted conveyor passing through the second tube,
a sprocket (“second sprocket”) externally of the second tube to move the conveyor flights into, in and from the second tube,
a pick up zone at or adjacent the inlet end of the second tube to which items from said discharge and transfer zone are transferred and from which the items to be immersed in the liquid can be dragged by a flight of the conveyor, and
a discharge zone at or adjacent the outlet end of the second tube from which items that have been dragged through the pooled liquid in the second tube are discharged.

21. An apparatus for a method of enhancing food safety and longevity of produce that has been subject to a mechanical reduction, said apparatus having,
in series,
(I) UV irradiation apparatus to irradiate the produce pieces whilst in a first liquid system as carrier,
(II) a first immersion apparatus to receive produce pieces directly or indirectly from step (I) apparatus, to immerse them in a different liquid system, and to discharge produce pieces, and
(III) a second immersion apparatus to receive the discharge from the first immersion apparatus and to discharge the produce pieces,
wherein the step (II) apparatus has
a first tube having an inlet and an outlet end and having between said inlet and outlet ends a region in which at least water can pool,
a liquid inlet and outlet into and from the first tube to provide a pool of at least water in said region of the first tube where at least water can pool,
an endless flighted conveyor passing through the first tube,
a sprocket (“first sprocket”) externally of the first tube to move the conveyor in flights into, in and from the first tube,
a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,
a discharge and transfer zone at or adjacent the outlet end of the first tube from which items that have been dragged through the pooled first liquid in the first tube are discharged,
and wherein the step (III) apparatus has
a second tube having an inlet and an outlet end and having between said inlet and outlet ends a region in which a second liquid can pool,
a liquid inlet and outlet into and from the second tube to provide a pool of a liquid being at least water at or near 0° C. [and with (optionally) a calcium cation and/or ascorbate anion inclusion] in said region of the second tube where a second liquid can pool,
an endless flighted conveyor passing through the second tube,
a sprocket (“second sprocket”) externally of the second tube to move the conveyor flights into, in and from the second tube,
a pick up zone at or adjacent the inlet end of the second tube to which items from said discharge and transfer zone are transferred and from which the items to be immersed in the liquid can be dragged by a flight of the conveyor, and
a discharge zone at or adjacent the outlet end of the second tube from which items that have been dragged through the pooled liquid in the second tube are discharged.

22. The apparatus of claim 21 wherein the step (I) apparatus irradiation apparatus is adapted to receive produce pieces into an induced and/or forced liquid vortex, there being at least one UV source capable of irradiating such produce pieces whilst in the vortex and/or downstream thereof.

23. The apparatus of claim 21 wherein at least some, if not all, of the flights of said conveyor(s) are perforate or contoured to reduce sticking of items and/or pieces thereto.

24. The apparatus of claim 21 wherein at least one discharge zone involve a deflector adapted to deflect and cause vibration of the flight to assist discharge of items or pieces (e.g. by flick off).

25. The apparatus of claim 21 wherein said tube or tubes are at least substantially circular in section.

26. The apparatus of claim 21 wherein said tubes are of a stainless steel.

27. The apparatus of claim 21 wherein said tubes have at least substantially horizontal regions at the inlet and at the outlet ends thereof.

28. The apparatus of claim 21 wherein the region of the tube(s) to carry a pooled liquid is below the level of both the inlet and the outlet of that tube thereby avoiding the need for a locus of the tube that would prevent run out.

29. The apparatus of claim 21 wherein said endless flighted conveyor involves a cable or sleeved cable to which is affixed the flights.

30. The apparatus of claim 21 wherein said flights are sufficiently loosely fitted to the tube so as to allow a flow past of liquid.

31. The apparatus of claim 21 wherein the sprockets are individually drivable i.e. so it is not necessary for each of the preferably serially related endless flighted conveyors to move at the same speed.

32. The apparatus of claim 21 wherein a vibratory screen, vibratory conveyor and/or air knife is provided for reducing liquid carry over [e.g. from (I) to (II) or (II) to (III)].

33. An apparatus for a method of enhancing food safety and longevity of produce that has been subject to a mechanical reduction, said apparatus having,
in series,
(I) UV irradiation apparatus to irradiate the produce pieces whilst in a first liquid system as carrier, [and optionally a liquid recovery and/or recycle system that involves a vibratory conveyor adapted to shed excess liquid from the produce pieces]
(II) a first immersion apparatus to receive produce pieces directly or indirectly from step (I) apparatus, to immerse them in a different liquid system, and to discharge produce pieces, and
(III) a second immersion apparatus to receive the discharge from the first immersion apparatus and to discharge the produce pieces,
wherein the step (II) apparatus has
a first tube having an inlet and an outlet end and having between said inlet and outlet ends a region in which at least water can pool,
a liquid inlet and outlet into and from the first tube to provide a pool of at least water in said region of the first tube where at least water can pool,
an endless flighted conveyor passing through the first tube,
a sprocket (“first sprocket”) externally of the first tube to move the conveyor in flights into, in and from the first tube,
a pick up zone at or adjacent the inlet end of the first tube from which items that have been UV light treated [optionally in water and optionally in water with a CaCl₂ of the equivalent inclusion(s)] to be immersed in the first liquid can be dragged by a flight of the conveyor,
a discharge and transfer zone at or adjacent the outlet end of the first tube from which items that have been dragged through the pooled first liquid in the first tube are discharged,
and wherein the step (III) apparatus has
a second tube having an inlet and an outlet end and having between said inlet and outlet ends a region in which a second liquid can pool,
a liquid inlet and outlet into and from the second tube to provide a pool of a liquid being at least water at or near 0° C. [and with (optionally) a calcium cation and/or ascorbate anion inclusion] in said region of the second tube where a second liquid can pool,
an endless flighted conveyor passing through the second tube,
a sprocket (“second sprocket”) externally of the second tube to move the conveyor flights into, in and from the second tube,
a pick up zone at or adjacent the inlet end of the second tube to which items from said discharge and transfer zone are transferred and from which the items to be immersed in the liquid can be dragged by a flight of the conveyor, and
a discharge zone at or adjacent the outlet end of the second tube from which items that have been dragged through the pooled liquid in the second tube are discharged.

34. A method of serially immersing UV light treated fresh and/or live vegetable and/or fruit pieces (“item”) which involves the steps of immersing the items in a first liquid system and immersing the items in a second liquid system,
wherein the first liquid system is at a temperature above that of the second liquid system.

35. The method of claim 34 wherein at least one of the steps involves dragging with the flights of a conveyor.

36. The method of claim 34 wherein there is a previous step of UV irradiation in a calcium chloride containing liquid system.

37. The method of claim 34 wherein said second liquid system is, or is primarily, water at or near 0° C.

38. The method of claim 34 wherein the first liquid system is at above ambient temperature or temperatures but below 70° C.

39. The method of claim 38 wherein the first liquid system is at from 15 to 55° C.

40. The method of claim 37 wherein said second liquid system contains a preservative.
